(19) United States
(12) Patent Application Publication
(10) Pub. No.: US 2007/0210138 A1
(43) Pub. Date: Sep. 13, 2007

(54) Circuit board pallet with magnetized pins

(75) Inventors: James Gleason, Garland, TX (US); Eric Nelson, Richardson, TX (US)

Correspondence Address: Rudolf O. Siegesmund, Suite 2600, 2100 Ross Avenue., Dallas, TX, 75201, US

(73) Assignee: Gleason Service Management

(21) Appl. No.: 11/371,800

(22) Filed: Mar. 9, 2006

(51) Int. Cl. A47J 36/02

(52) U.S. Cl. 228/101

(57) ABSTRACT

The circuit board pallet comprises one or more flat metallic spring arms positioned over magnetized pins. The magnetized pins comprise a magnetic material, such as steel. The magnetized pains contact a permanent magnet embedded inside or attached under the pallet. The metallic spring arms comprise a flexible magnetic material, such as spring steel. The metallic spring arms hold a circuit board to the pallet by a magnetic force created by the permanent magnets which attracts the spring arms towards the pins. The magnetized pins can also be used to secure component placement jigs to the circuit boards pallet.

### FIELD OF THE INVENTION

The present invention is directed, in general, to a pallet with a spring arm and magnetized pin for accurately positioning and holding a printed circuit board during manufacturing processes.

### BACKGROUND OF THE INVENTION

Circuit board manufacturing is well known in the art. Electrical components such as processors, memory, capacitors, diodes, resistors, and the like attach to a blank circuit board to create a board for installation in an electrical device such as a computer. The blank circuit board must be held in place during the manufacturing process, usually through the use of a circuit board pallet. The circuit board must perfectly align with the pallet for accurate application of solder and components.

The circuit board undergoes a step called solder stenciling during the manufacturing process. During the solder stenciling step, the printed circuit board enters a solder stenciling machine. A portion of the solder stenciling machine lowers onto the printed circuit board from above and deposits solder onto the printed circuit board. Clamps for holding circuit boards to the pallet must not protrude above the surface of the top of the pallet because the protrusions interfere with the solder stenciling machine, preventing the machine from contacting the board and depositing the solder paste. The solder stenciling machine exerts a slight suction or adhesion which can lift the circuit board upwards after solder deposition. Pallets must be machined to hold the printed circuit board in position during solder stenciling and other steps of the circuit board manufacturing process.

Recessed spaces, or cavities, in pallets allow the circuit board to remain flat when components extend through to the back side. Cavities in the pallet can also be used when components have previously been mounted to the back side of the circuit board. Pallets may also have a means for attaching a jig to the top of a circuit board. Jigs have cut-outs used to align and support components mounted to the front of circuit board.

Pallets vary in size and thickness depending on the size of the printed circuit board. Since the pallets are reused numerous times, an apparatus for positioning and holding the printed circuit board must be simple, reliable, easy to manufacture and inexpensive. The printed circuit board must be held in position so that it does not move from side to side or upward, away from the pallet. If the circuit board bends or moves, components, solder and leads will not align properly. Therefore, a way to apply pressure to the printed circuit board to hold it in place without deformation is needed.

There exists in the art several methods to secure printed circuit boards to the pallet. Some pallets are made by machining a suitable material to create a recessed space in the pallet for receiving the entire printed circuit board. When positioned within the recessed space, the printed circuit board lies flat and level with or parallel to the top surface of the pallet. Various shaped pins or clamps position and hold the circuit board in place.

One method of holding circuit boards to pallets uses adhesive tape. Either adhesive tape holds the back side of a circuit board to the pallet, or adhesive tape stretches across a portion of the top the circuit board, clamping the circuit board to the pallet. A drawback to adhesive tape is loss of adhesion. Over time, the sticky qualities of adhesive tape degrade, and circuit boards will not be held securely. Heat from processes such as solder reflow accelerates the degradation of the tape. As a result, tape must be replaced frequently.

U.S. Pat. No. 6,012,713 discloses a pallet for holding a printed circuit board during the solder stenciling step wherein one or more lever arms cut from the pallet material hold the printed circuit board. The lever arm or arms exert pressure against the printed circuit board by compression or through tension by the addition of a pin to the lever arm.

Tension and compression clamps are suitable for thick and sturdy circuit boards capable of handling the horizontal stress or pressure. Newer circuit boards, however, are made from very thin and/or flexible materials. Compression clamps can warp thin circuit boards, especially when subject to light vertical forces, like the upward force created by the solder stenciling machine. Tension clamps with pins can bend or even tear very thin circuit boards.

A need exists for a repeatable method of positioning and holding very thin circuit boards to reflow pallets without damaging or deforming the circuit board.

### SUMMARY OF THE INVENTION

An apparatus that meets the need identified above is a circuit board pallet comprising one or more flat metallic spring arms positioned over magnetized pins. The magnetized pins comprise a magnetic material, such as steel. The magnetized pins contact a permanent magnet embedded inside or attached under the pallet. Alternatively, the magnetized pins are made from a permanent magnet. The metallic spring arms comprise a flexible magnetic material, such as spring steel. The metallic spring arms hold a circuit board to the pallet by a magnetic force created by the permanent magnets which attracts the spring arms towards the pins. The spring arms mount to the pallet so that they swivel about a vertical axis, rotating away from the magnetized pins to allow for placement and removal of circuit boards. The spring arms mount in a recess such that the mounts do not extend above the top plane of the pallet.

In one embodiment of the invention, the magnetized pins extend upwardly from the pallet surface into positioning holes located on the circuit board. In another embodiment, the magnetized pins are flush with the pallet's top surface.

Another embodiment of the invention comprise a jig placed on top of a circuit board, holding the circuit board to the pallet. The jig is comprised of the same material as the pallet, having openings for the placement of electronic components. Magnetic material or permanent magnets embedded in the jig hold the jig in place above the pallet's magnetized pins by a magnetic force.

Another embodiment of the invention comprises a long metallic spring arm mounted to at least one location on the pallet. The long metallic spring arm substantially extends over an entire edge of a circuit board. The long metallic spring arm holds a circuit board to the pallet by a magnetic force created by at least one permanent magnet which attracts the spring arm towards at least one magnetized pin.

### BRIEF DESCRIPTION OF DRAWINGS

The novel features believed characteristic of the invention are set forth in the appended claims. The invention itself, however, as well as a preferred mode of use, further objectives and advantages thereof, will be understood best by references to the following detailed description of an illustrative embodiment when read in conjunction with the accompanying drawings, wherein:

FIG. 1A shows a prior art circuit board pallet with a flexible tension arm.

FIG. 1B shows a prior art circuit board pallet with flexible compression arms.

FIG. 2 shows an exploded view of the invention and an exemplary circuit board.

FIG. 3A shows a cross section of the pallet and a circuit board.

FIG. 3B shows a cross section of a circuit board secured to the pallet.

FIG. 3C shows an alternate embodiment of the magnetized pin.

FIG. 3D shows an alternate embodiment of the magnetized pin.

FIG. 4A shows an exploded view of the pallet used with a jig.

FIG. 4B shows a cross section of alternate embedded couplings on a jig.

FIG. 5 shows an alternate embodiment of the metallic spring arm.

### DETAILED DESCRIPTION OF THE PREFERRED EMBODIMENT

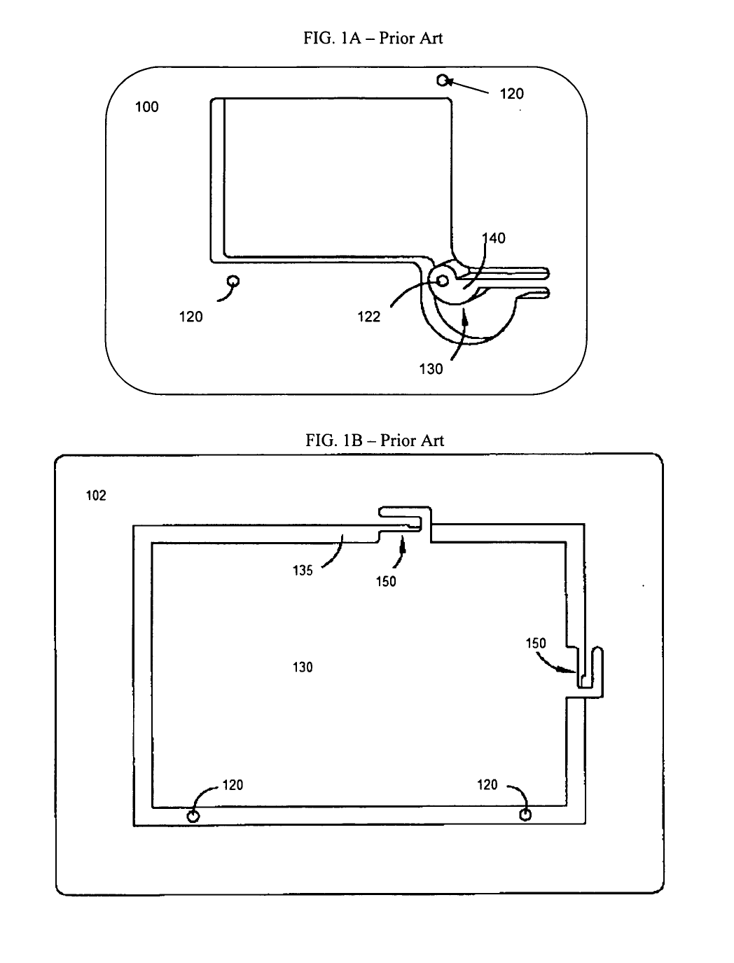

FIG. 1A shows a prior art circuit board pallet 100 with a flexible tension arm 140 and a pin 122. Additional fixed pins 120 aid in locating and securing circuit boards. Pins 120 and 122 engage with circuit board locator holes. Force from tension arm 140 pulls the circuit board away from fixed pins 120, holding a circuit board in place. Flexible tension arm 140 is machined from the pallet material. A cavity around arm 140 allows room for flexing. Tension arms made from other suitable materials using a spring and shaft apparatus placed inside a cavity on the pallet are known in the art.

FIG. 1B shows a prior art circuit board pallet 102 with flexible compression arms 150. Additional fixed pins 120 aid in locating and securing circuit boards. Compression arms 150 are machined from the pallet material. A cavity around the compression arms 150 allows room for flexing. A shelf area 135 around the cavity perimeter contacts the back edge of a circuit board. Compression arms 150 press against circuit boards placed into cavity 130, securing circuit boards against the opposite wall of cavity 130 and fixed pins 120. Compression arms made from other suitable materials using a spring and shaft apparatus placed inside a cavity on the pallet are known in the art.

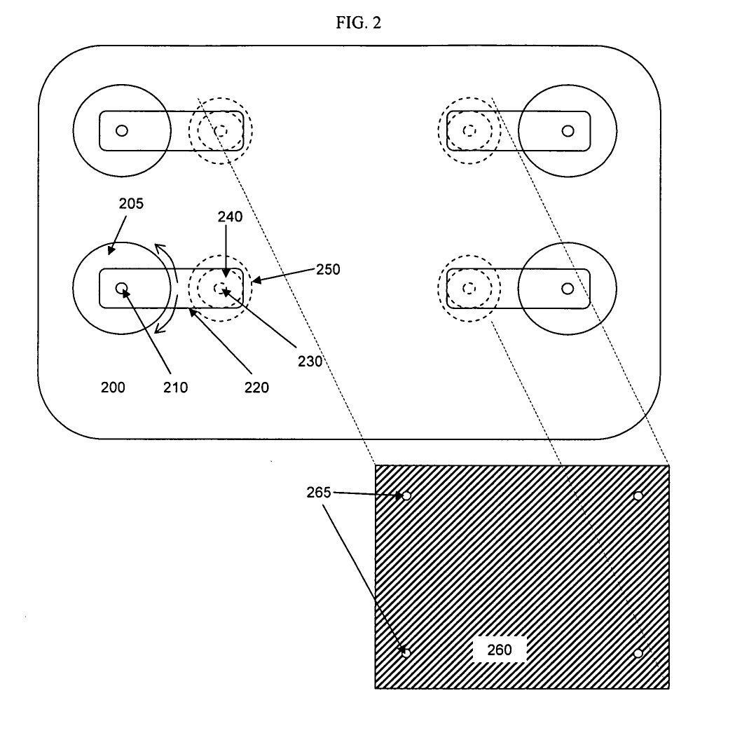

FIG. 2 shows an exploded view of the pallet 200 and an exemplary blank circuit board 260. At least one pin 230 inserts into pallet 200, pin 230 backed by a permanent magnet 240. Pin 230 is made of a magnetic material, such as steel. Epoxy 250 or some other material bonds permanent magnet 240 to the back side of pallet 200. Alternatively, magnet 240 is pressed into the back side of pallet 200 without requiring an adhesive. A swivel joint pin 210 secures a thin, flexible metallic arm 220 to pallet 200 so that arm 220 pivots about a vertical axis. Metallic arm 220 comprises a flexible magnetic material, such as spring steel. Metallic arm 210 secures in a shallow cavity 205 so that the top of swivel joint pin 210 is at or below the plane of the top surface of pallet 200. Placement of magnetized pins 230 on the pallet corresponds with alignment holes 265 on circuit board 260. Metallic arm 220 attaches outside the perimeter defined by circuit board 260 when placed on pallet 200. Metallic arm 220 extends to contact magnetized pin 230. After circuit board 260 engages with pallet 200, metallic arm 220 pivots over circuit board 260 and magnetized pin 230. The magnetic force of magnetized pin 230 attracts the metallic arm 220, securing circuit board 260. Metallic arm 220 is thin enough to not interfere with the solder reflow process.

Other non-magnetized locator pins not shown here may also assist in alignment of circuit board 260 on pallet 200. Various pin shapes for interfacing with circuit boards and means for securing pins to the pallet are known in the art. An alternative embodiment uses pins made from a permanent magnet. One skilled in the art will understand how to adapt this invention to known pin variations and configurations. Although the drawings show circuit board 260 resting on the top surface of pallet 200, the invention can be adapted for pallets where the circuit board is located in a recessed cavity on the top side of the pallet. Additional cavities in pallets are commonly used to allow circuit boards to remain flat while components extend through to the back of the circuit board.

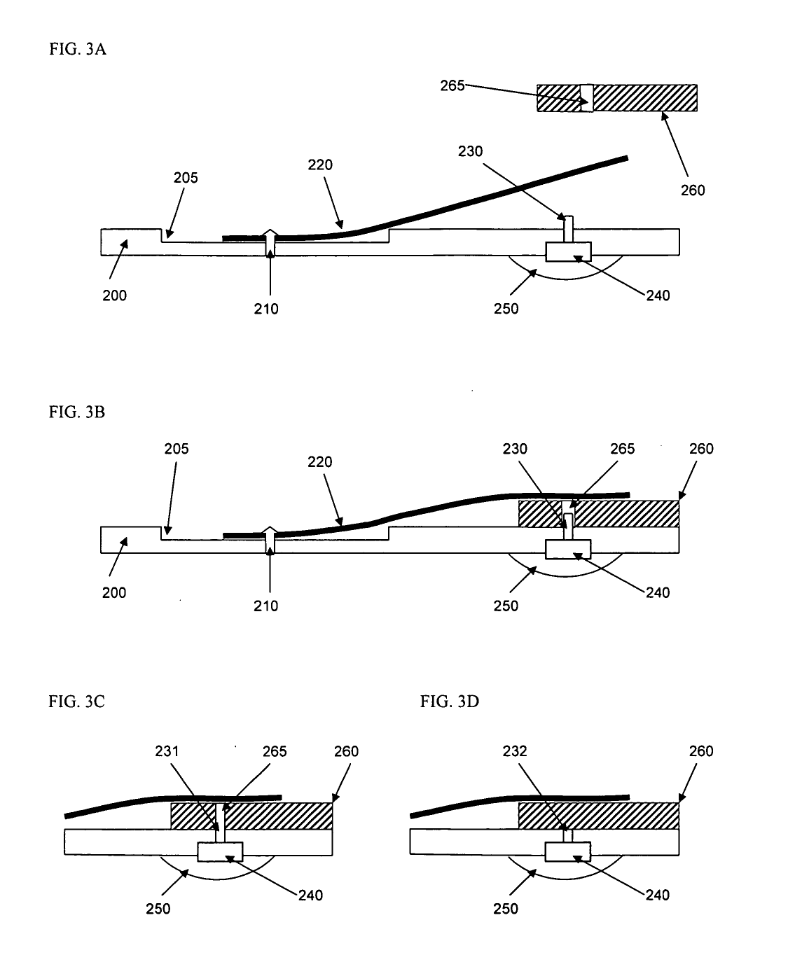

FIG. 3A shows a cross section view of pallet 200 and circuit board 260. At least one pin 230 inserts into pallet 200. Pin 230 comprises a magnetic material, such as steel. Epoxy 250 or some other material secures permanent magnet 240 to the back side of pallet 200, in contact with magnetized pin 230. Swivel joint pin 210 secures thin, flexible metallic arm 220 so that it can pivot about a vertical axis. Metallic arm 220 secures in shallow cavity 205 so that the top of swivel joint pin 210 is at or below the plane of the top surface of pallet 200. Metallic arm 220 comprises a flexible, magnetic material, such as spring steel. Placement of magnetized pin 230 on pallet 200 corresponds with alignment holes 265 on circuit board 260. Metallic arm 220 attaches outside the perimeter defined by circuit board 260 when placed on pallet 200. Metallic arm 220 extends above magnetized pin 230.

FIG. 3B shows a cross section of circuit board 260 secured to pallet 200. Alignment hole 265 in circuit board 260 is placed over the magnetized pin. After circuit board 260 engages with pallet 200, metallic arm 220 pivots over circuit board 260 and magnetized pin 230. The magnetic force of magnetized pin 230 attracts the metallic arm 220, securing circuit board 260. In this embodiment, magnetized pin 230 protrudes from pallet 200 into alignment hole 265 on circuit board 260, but magnetized pin 230 does not protrude far enough through circuit board 265 to contact metallic arm 220.

FIG. 3C shows an alternate embodiment of magnetized pin 230. In this embodiment, magnetized pin 230 protrudes from pallet 200 into alignment hole 265 on circuit board 260, extending far enough through circuit board 265 to physically contact metallic arm 220.

FIG. 3D shows another embodiment of magnetized pin 230. In this embodiment, magnetized pin 230 does not protrude past the plane of the top surface of pallet 200. Magnetized pin 230 will not aid alignment of circuit board 260. Magnetized pin 230 does not physically contact metallic arm 220 with circuit board 260 placed on pallet 200.

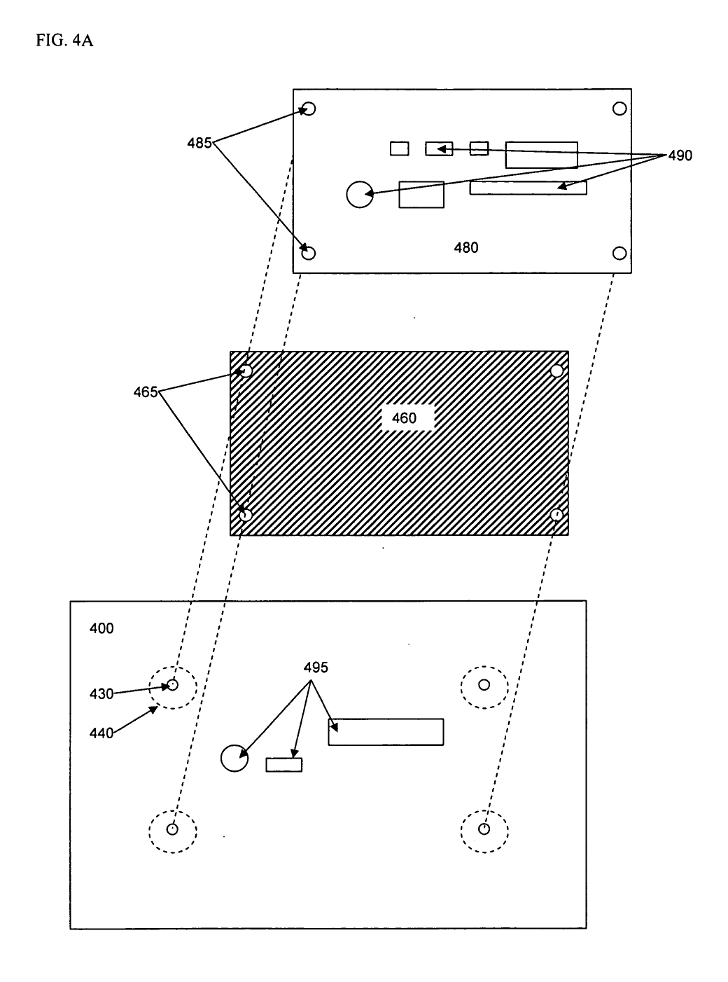

FIG. 4A shows an exploded view of pallet 400, an exemplary blank circuit board 460 and a circuit board component jig 480. Pin 420 helps position circuit board 460 through alignment hole 465 on pallet 400. Magnet 440 contacts the back of pin 420, magnetizing pin 420. Cavities 495 in pallet 400 allow for circuit board 460 to remain flat when components extend past the back side of circuit board 460. An integrated coupling 485 on jig 480 aligns over magnetized pin 430 and circuit board alignment hole 465. The magnetic attraction of magnetized pin 430 holds jig 480 down, over circuit board 460. Cut-outs 490 in jig 480 assist in positioning and holding components to circuit board 460 during various steps in the manufacturing process. The use of jigs for positioning and holding components to circuit boards is known in the art.

FIG. 4B shows cross sections of coupling 485. One alternative of coupling 485 comprises cap 486 made of magnetic material embedded inside jig 480. Another alternative of coupling 485 comprises magnet 488 secured to the jig above alignment hole 487. Magnet 488 must be oriented with the same polarity as the corresponding magnet 440 on the pallet or else the magnets will repel each other rather than attract to each other.

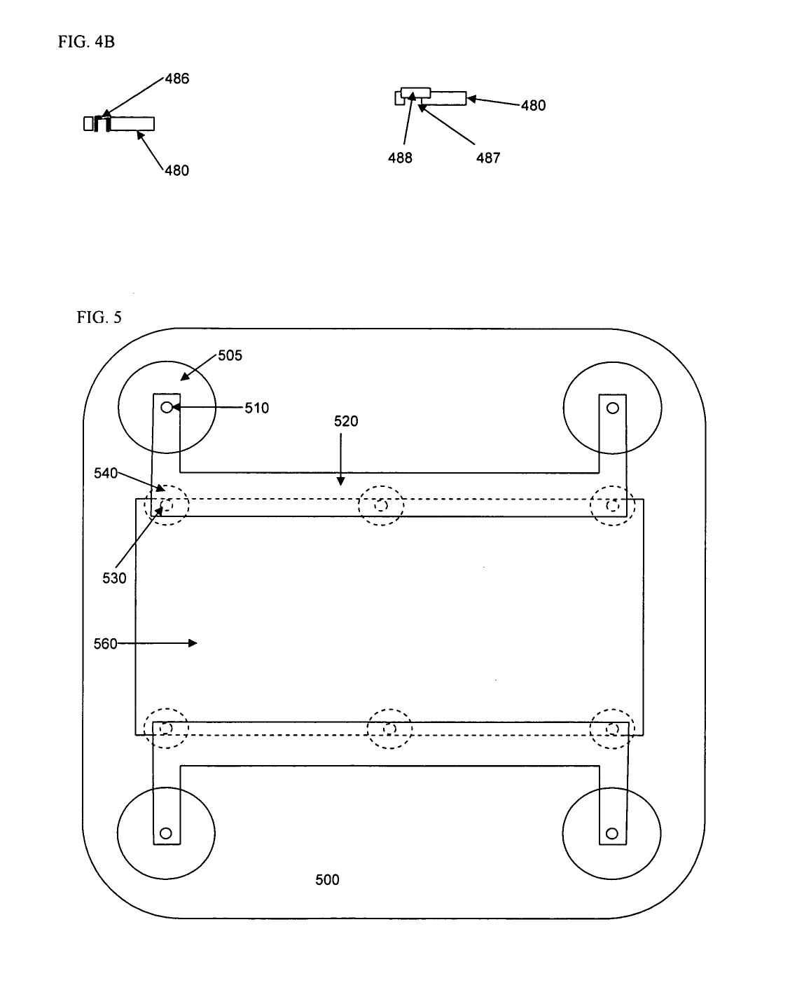

FIG. 5 shows an alternate embodiment of the pallet 500. A long metallic spring arm 520 mounts 510 to at least one location on pallet 500. Long metallic spring arm 520 substantially extends over an entire edge of a circuit board 560. Long metallic spring arm 520 holds circuit board 560 to pallet 500 by a magnetic force created by at least one permanent magnet 540 which attracts spring arm 520 towards at least one magnetized pin 530.

A preferred form of the invention has been shown in the drawings and described above, but variations in the preferred form will be apparent to those skilled in the art. The preceding description is for illustrative purposes only, and the invention should not be construed as limited to the specific form shown and described. The scope of the invention should be limited only by the language of the following claims.

What is claimed is:

1. An apparatus for positioning and holding a printed circuit board during manufacturing comprising:
a pallet for receiving the printed circuit board;
at least one magnetic metal pin affixed to top of the pallet; and
at least one flexible magnetic metallic arm affixed to the top of pallet, wherein pressure caused by the magnetic force created by the at least one magnetic pin attracting the at least one flexible magnetic metallic arm holds the printed circuit board to the pallet.

2. The apparatus of claim 1 further comprising at least one permanent magnet affixed to the bottom of the pallet, wherein the permanent magnet is in direct contract with the at least one magnetic metal pin, the at least one permanent magnet in contact with the at least one magnetic metal pin creates the magnetic force for attracting the at least one flexible magnetic metallic arm holds the printed circuit board to the pallet.

3. The apparatus of claim 1 wherein the top of the magnetic metal pin is flush with the top of the pallet.

4. The apparatus of claim 1 wherein the printed circuit board has at least one hole for receiving a pin, the at least one magnetic metal pin of said apparatus extending above the top of the pallet for mating with said hole.

5. The apparatus of claim 4 wherein the at least one magnetic metal pin extends through the at least one hole to the top side of the printed circuit board and physically contacts the at least one flexible magnetic arm.

6. The apparatus of claim 1 wherein the at least one flexible magnetic metallic arm affixes by a swivel joint pin so that the at least one flexible magnetic arm pivots around a vertical axis.

7. The apparatus of claim 6 wherein the at least one flexible magnetic metallic arm affixes to a shallow cavity in the pallet so the top of the swivel joint pin is at or below the plane of the top of the pallet.

8. The apparatus of claim 1 wherein the at least one flexible magnetic metallic arm is thin enough to not interfere with a solder stenciling process.

9. The apparatus of claim 1 wherein the at least one flexible magnetic metallic arm is made of spring steel.

10. The apparatus of claim 1 wherein the pallet comprises a plurality of cavities.

11. The apparatus of claim 2 wherein the at least one permanent magnet is pressed into a cavity in the pallet.

12. The apparatus of claim 2 wherein the at least one permanent magnet is affixed to the pallet by epoxy.

13. An apparatus for positioning and holding a printed circuit board having a plurality of holes during manufacturing comprising:
a pallet for receiving the printed circuit board;
a plurality of magnetic metal pins affixed to top of the pallet; and
a jig having a plurality of cut-outs,
wherein a plurality of integrated couplings on the jig align over the magnetic metal pins, clamping the printed circuit board to the pallet.

14. The apparatus of claim 13 where the plurality of integrated couplings on the jig comprise magnetic metallic cups, wherein pressure caused by the magnetic force created by the plurality of magnetic metal pins attracting the plurality of magnetic metallic cups holds the printed circuit board and the jig to the pallet.

15. The apparatus of claim 14 further comprising: a plurality of permanent magnets affixed to the bottom of the pallet, wherein the permanent magnet is in direct contract with the plurality of magnetic metal pins, the at least one permanent magnet in contact with the at least one magnetic metal pin creates the magnetic force for attracting the plurality of magnetic metallic cups holds the printed circuit board and the jig to the pallet.

16. The apparatus of claim 13 where the plurality of integrated couplings on the jig comprise embedded permanent magnets, wherein pressure caused by the magnetic force created by the plurality of permanent magnets in contact with the plurality of magnetic metal pins attracting the plurality of permanent magnets holds the printed circuit board and the jig to the pallet.

17. The apparatus of claim 13 wherein the pallet comprises a plurality of cavities.

18. An apparatus for positioning and holding a printed circuit board during manufacturing comprising:
a pallet for receiving the printed circuit board;
at least one magnetic metal pin affixed to top of the pallet; and
at least one flexible magnetic metallic arm affixed to the top of pallet, substantially extending over an entire edge of the circuit board, wherein pressure caused by the magnetic force created by the at least one permanent magnet in contact with the at least one magnetic metal pin attracting the at least one flexible magnetic metallic arm holds the printed circuit board to the pallet.

19. The apparatus of claim 18 further comprising at least one permanent magnet affixed to the bottom of the pallet, wherein the permanent magnet is in direct contract with the at least one magnetic metal pin, the at least one permanent magnet in contact with the at least one magnetic metal pin creates the magnetic force for attracting the at least one flexible magnetic metallic arm holds the printed circuit board to the pallet.

20. The apparatus of claim 18 wherein the top of the magnetic metal pin is flush with the top of the pallet.

21. The apparatus of claim 18 wherein the printed circuit board has at least one hole for receiving a pin, the at least one magnetic metal pin of said apparatus extending above the top of the pallet for mating with said hole.

22. The apparatus of claim 18 wherein the at least one magnetic metal pin extends through the at least one hole to the top side of the printed circuit board and physically contacts the at least one flexible magnetic arm.

23. The apparatus of claim 18 wherein the at least one flexible magnetic metallic arm affixes by a swivel joint pin so that the at least one flexible magnetic arm pivots around a vertical axis.

24. The apparatus of claim 23 wherein the at least one flexible magnetic metallic arm affixes to a shallow cavity in the pallet so the top of the swivel joint pin is at or below the plane of the top of the pallet.

25. The apparatus of claim 18 wherein the at least one flexible magnetic metallic arm affixes at a plurality of points.

26. The apparatus of claim 25 wherein the at least one flexible magnetic metallic arm affixes to a plurality of shallow cavities in the pallet so the top of the connectors are at or below the plane of the top of the pallet.

27. The apparatus of claim 18 wherein the at least one flexible magnetic metallic arm is thin enough to not interfere with a solder stenciling process.

28. The apparatus of claim 18 wherein the at least one flexible magnetic metallic arm is made of spring steel.

29. The apparatus of claim 18 wherein the pallet comprises a plurality of cavities.

30. The apparatus of claim 19 wherein the at least one permanent magnet is pressed into a cavity in the pallet.

31. The apparatus of claim 19 wherein the at least one permanent magnet is affixed to the pallet by epoxy.
